(19) United States
(12) Patent Application Publication
(10) Pub. No.: US 2010/0278588 A1
(43) Pub. Date: Nov. 4, 2010

(54) CONNECTION DEVICE

(75) Inventor: Steffen Jaekel, Hiddenhausen (DE)

Correspondence Address: BARNES & THORNBURG LLP, 750-17TH STREET NW, SUITE 900, WASHINGTON, DC, 20006-4675, US

(73) Assignee: PAUL HETTICH GMBH & CO.KG, Kirchlengern (DE)

(21) Appl. No.: 12/771,843

(22) Filed: Apr. 30, 2010

(30) Foreign Application Priority Data
May 2, 2009 (DE) 20 2009 006 443.3

(51) Int. Cl. F16B 12/10

(52) U.S. Cl. 403/388

(57) ABSTRACT

A connection device for connecting first and second furniture components to one another and which furniture components are adjustable with respect to one another. The connection device includes at least two connection elements spaced-apart from one another and located on the second furniture component and at least two adjustment holes spaced-apart from one another and located on the first furniture component. Distances between the at least two connection elements are different from distances between the at least two adjustment holes.

### BACKGROUND OF THE INVENTION

This is an application claiming priority to and benefit of German Patent Application Number 20 2009 006 443.3 filed May 2, 2009 in Germany, the subject matter of which is incorporated by reference herein.

### BACKGROUND SUMMARY

The present disclosure relates to a connection device for a first and a second furniture component, which components are connectable to form a module and are adjustable with respect to one another.

The furniture components to be connected to one another are known in many embodiments. In certain embodiments, the components to be connected to form a module are displaceable in an oscillating manner in relation to a guide fixedly attached to the furniture body. In addition to the capability of connecting the two furniture components so they are not displaceable, it must be ensured that the two furniture components may be oriented in relation to one another. This is performed, for example, by turning adjustment screws or similar elements.

Such embodiments have proven themselves. However, the adjustment is to be viewed as cumbersome with respect to the handling.

The present disclosure relates to a connection device configured such that the two furniture components to be connected form a module and may be adjusted with respect to one another without the use of adjustment screws and without the aid of tools.

The present disclosure relates to at least two connection elements located at a distance from one another. The two connection elements are provided in the second furniture component, and at least a piece count or a number of adjustment holes corresponding to the number of the connection elements is provided in the first furniture component. The distances between the fixing elements deviate from the distances between the adjustment holes, and the connection elements and the adjustment holes lie in the same or a common displacement plane.

As long as the two furniture components are not yet connected to one another, one furniture component can be displaced in relation to the other furniture component by a minimal amount in the displacement plane for the purpose of adjustment. Due to the differing distances between the adjustment holes and the connection elements, only one connection element can engage in an associated adjustment hole. The remaining connection elements are supported on the edges delimiting the adjustment holes and are accordingly inactive.

In one embodiment according to the present disclosure, it is provided that three spaced-apart adjustment holes are provided in the first furniture component and three spaced-apart connection elements are provided in the second furniture component. The middle adjustment hole in the middle connection element can be considered as the setting element for the basic setting for the furniture parts, or components, and the two lateral adjustment holes and connection elements can be considered for the correction.

In a first embodiment, it is provided that the connection elements are implemented, for example, as adjustment bolts which are movable in their longitudinal direction and in the longitudinal direction of the adjustment holes. The particular adjustment bolt engaging in an adjustment hole engages in the particular adjustment hole over a part of the length.

Furthermore, it is provided that the distances between the connection elements are greater or less than the distances between the adjustment holes. In another embodiment, however, it is provided that the distances between the connection elements are equal among one another.

In order that the particular connection bolt plunging into an adjustment hole can also reliably plunge into the adjustment hole, it is provided that each connection bolt is loaded using one force accumulator, for example, a spring.

For secure guiding of the connection bolts, it is provided that they are guided in a closing manner in a guide, or guide channel, which is provided in a guide plate fixed on the second furniture component.

In a further embodiment according to the present disclosure, for example, it is provided that the connection bolts are provided on the end areas facing toward the force accumulators with one unlocking pin in each case, which runs transversely to the central longitudinal axis of the particular connection bolt. These unlocking pins allow the particular connection bolt plunging into an adjustment hole to be able to be brought into a release position, so that subsequent adjustment is still possible, or the furniture components connected to one another may be decoupled.

In order that the unlocking pins may be moved through the adjustment hole against the action of the force accumulator for the purpose of release, it is provided that the guide channels are open or have slots at least on the side associated with the unlocking pins. However, the guide channels are expediently open on the sides opposite to one another. It is also to be noted that the guide plate is fixedly connected to the second furniture component.

In order that the release of the particular connection bolt can be achieved in the simplest way, it is provided that an unlocking slide, which is guided so it is displaceable in the longitudinal direction of the locking bolt, and which is operationally linked to the unlocking pins, is situated on the guide plate on the side associated with the unlocking pins. This operational link is achieved simply in that the unlocking slide is provided with an unlocking web provided on the side facing toward the connection bolt, which is provided with recesses, in which the unlocking pins engage. These recesses engage behind the unlocking pins. In order to be able to execute the unlocking optimally, it is provided that an actuating lever is mounted so it is pivotable on the guide plate, to which the unlocking slide is linked.

In a further embodiment according to the present disclosure, it is provided that the fixing or connection elements are implemented as spring tongues, which are attached to, molded on, or shaped from a holder. These spring tongues are designed so that the free end areas snap into one of the adjustment holes, as soon as this spring tongue is aligned with the adjustment hole.

However, it must also be ensured in the case of this embodiment that unlocking occurs if needed. It is therefore provided that a bar is mounted so it is rotatable in the holder, which is provided with unlocking cams, which cooperate with the spring tongues upon rotation of the unlocking bar.

In the present disclosure, the first furniture component is designated as the one which has the adjustment holes and the second furniture component is the component which is equipped with the connection elements. In illustrative embodiments, it is provided, for example, that the first furniture component is a slide rail movable along a fixed guide rail and the second furniture part is, for example, the bottom of a drawer. In accordance with the present disclosure, the reverse is also possible, so that the bottom of the drawer is the first furniture component and the slide rail is the second furniture component.

Other aspects of the present disclosure will become apparent from the following descriptions when considered in conjunction with the accompanying drawings.

### BRIEF DESCRIPTION OF THE DRAWINGS

FIGS. 1a, 1b, 2a, 2b, 2c show a first embodiment of a connection device, according to the present disclosure, the connection device being shown in five different views, including showing a view through a guide plate in a central plane of connection elements.

FIGS. 3a, 3b, 4a, 4b, 4c show a second embodiment of a connection device, according to the present disclosure, the connection device being shown in five different views, including showing a view through a guide plate in a central plane of connection elements.

FIGS. 5a, 5b, 6a, 6b, 6c show a third embodiment of a connection device, according to the present disclosure, the connection device being shown in five different views.

### DETAILED DESCRIPTION

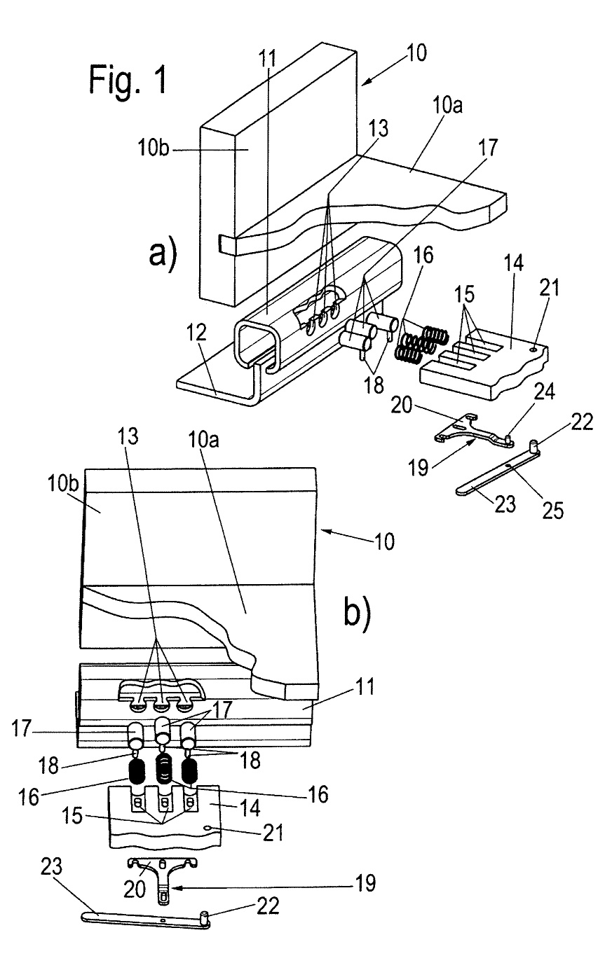

In accordance with the present disclosure, a connection device is described hereafter for connecting a partially shown drawer 10 to a slide rail 11, which slide rail 11 is movable along a guide rail 12 attached fixedly on a furniture body (not shown). For simplified illustration, only a bottom 10a and one side wall 10b of the drawer 10 are shown. As shown in FIG. 1, the slide rail 11 is equipped on the inner side facing away from the side wall 10b with three adjustment holes 13, which holes 13 are at the same height and are at equal distance from one another. A guide plate 14 is fixed on the lower side of the bottom 10a of the drawer 10 at the correct location for alignment with adjustment holes 13. For illustrative purposes, guide plate 14 is shown cut away above a plane of connection bolts 17. This guide plate 14 is provided on the side facing toward the slide rail 11 with three spaced apart guides 15, which are implemented as pocket holes. The walls delimiting the guides 15 run in a curve, however. A force accumulator, for example, a compression spring 16, is inserted into each guide 15. In addition, a connection bolt 17 is inserted into each guide 15. On the side facing away from the bottom 10a of the drawer 10, each connection bolt 17 is provided with an unlocking pin 18, which is located transverse to the central longitudinal axis of each locking bolt 17 and penetrates the guide plate 14 through an oblong hole. On the side facing away from the drawer 10a, an unlocking slide 19 is inserted so it is displaceable on the guide plate 14. This unlocking slide 19 is provided on the side facing toward the slide rail 11 with an unlocking web 20, which is transverse to the displacement direction of the unlocking slide 19. On the side facing away from the slide rail 11, the unlocking web 20 is provided with oblong holes, in which the unlocking pins 18 engage. The guide plate 14 is provided with a hole 21, in which a terminal journal 22 of an unlocking lever 23 is inserted. The unlocking slide 19 is linked on this unlocking lever 23. For this purpose, the unlocking slide 19 is provided on the side facing away from the slide rail 11 with a bearing journal 24, which engages in a hole 25 of the unlocking lever 23.

FIG. 1a shows an embodiment of a connection device, according to present disclosure, in a diagonal perspective exploded illustration, while FIG. 1b shows this connection device configuration in an exploded illustration transverse to the direction of FIG. 1a.

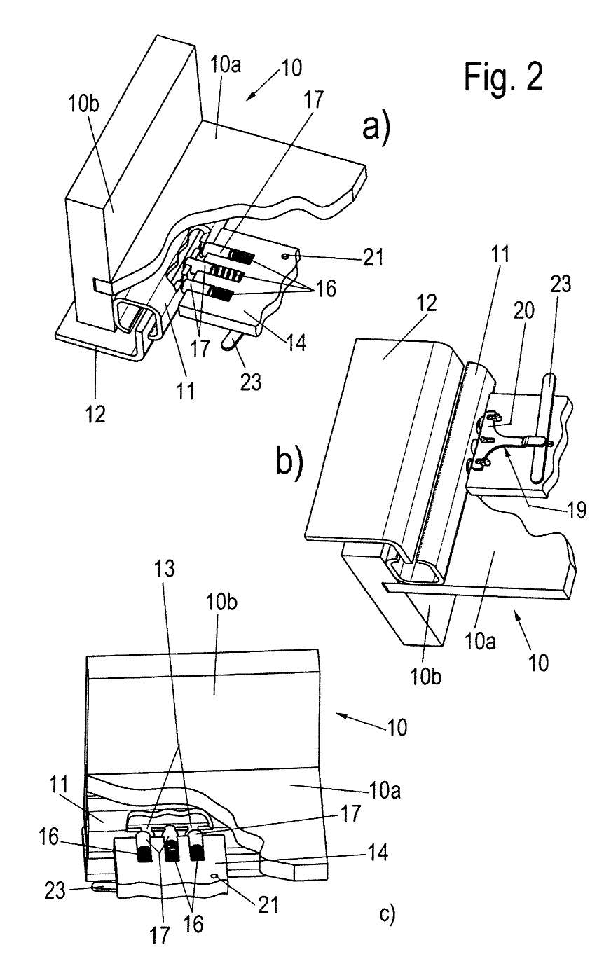

FIG. 2a shows a view similar to FIG. 1a, but the connection device is shown in the installed state. FIG. 2c shows this connection device in a top view and FIG. 2b shows this connection device rotated by 180°, that is, in a bottom view perspective.

Distances between the guides 15 and thus the connection bolt 17 deviate from distances between the individual adjustment holes 13, but lie in the same plane. The distances between the guides 15 are, slightly greater, for example, in the range of 2 mm, than the distances between the adjustment holes 13. FIGS. 2a, 2b, 2c show that the middle connection bolt 17 is retracted into an associated middle adjustment hole 13. In order to align the drawer 10 and the slide rail 11 to one another, either the drawer 10 or the slide rail 11 can be moved so that one of the outer connection bolts 17 engages in its associated adjustment hole 13. In the starting location, all connection bolts 17 are retracted. However, if one of the connection bolts 17 is retracted into an adjustment hole 13, the particular connection bolt 17 can be retracted against the action of the particular compression spring 16 by pivoting the unlocking lever 23, so that the connection between the drawer 10 and the slide rail 11 is detached, so that a mutual alignment can again be performed.

In the above-described embodiment of FIGS. 1a-2c, the slide rail 11 forms the first furniture component and the drawer 10 forms the second furniture component, which form a module through one adjustment hole 13 and an inserted connection bolt 17. The components are operationally linked to the connection bolt 17, which belongs to the connection device.

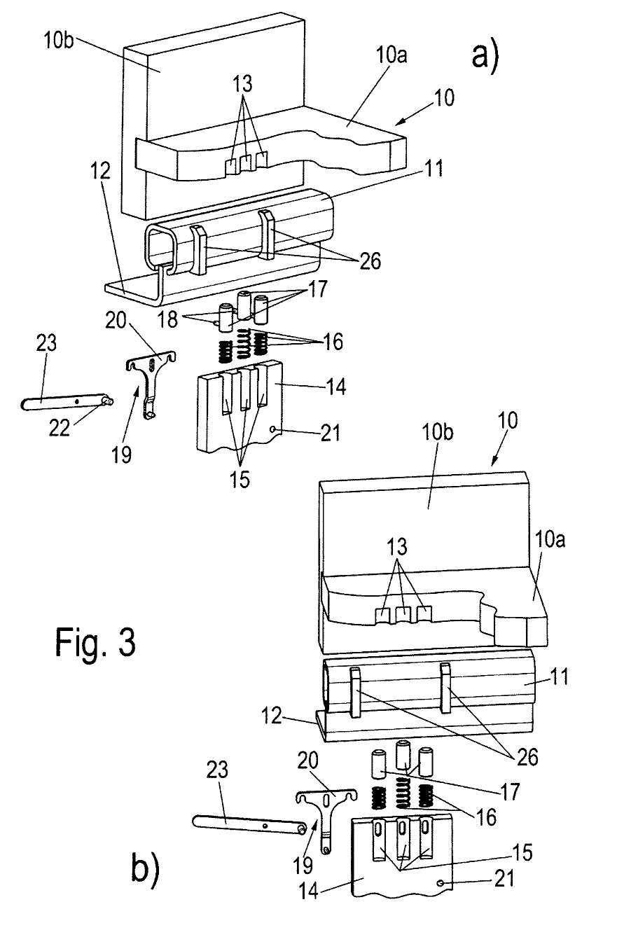

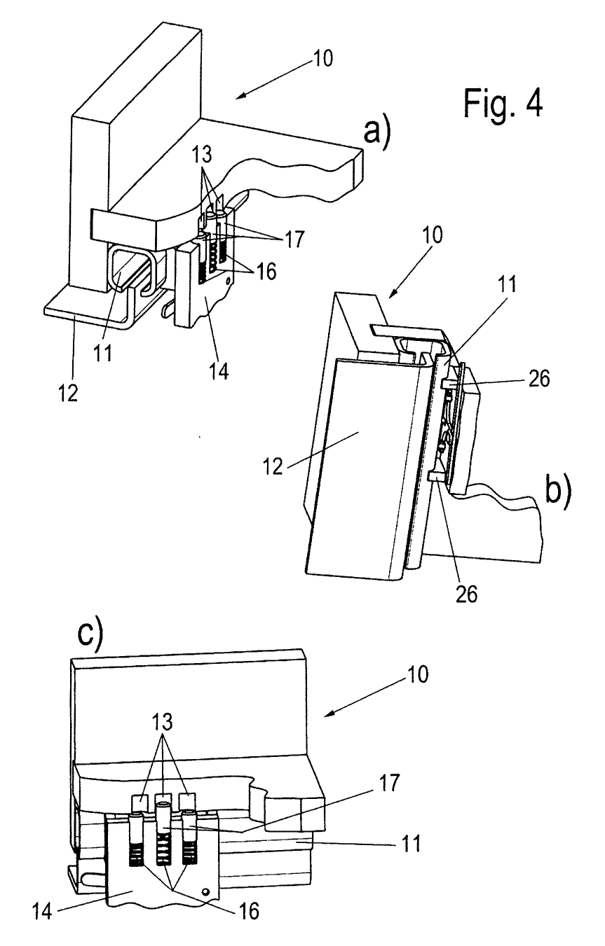

FIGS. 3a, 3b, 4a, 4b, 4c show another embodiment of a connection device, according to the present disclosure, having the same construction as shown in FIGS. 1a-2c, but the adjustment holes 13 are implemented as pocket holes originating from the lower side of the bottom 10a of the drawer 10. Regarding the guide plate 14, the side toward the observer is shown cut away up to a plane of the connection elements, including the inserted compression springs 16 and the connection bolts 17. The unlocking slide 19 and the unlocking lever 23 are shown in the exploded views of FIGS. 3a and 3b and are fixed on the slide rail 11, as suggested in FIGS. 4a-c. Accordingly, the guide plate 14 is parallel and at a distance to the side wall 10b of the drawer 10. The guide plate 14 is at a distance to the leg of the slide rail 11 facing toward it. For this purpose, two intermediate webs 26 are attached or molded onto this leg of the slide rail 11. The unlocking slide 19 is between these webs 26, as shown in FIGS. 3a, 3b, 4a, 4b, and 4c.

FIG. 3a shows the connection device in a perspective, exploded view. FIG. 3b shows the connection device in an exploded side view looking toward the side wall 10b of the drawer 10. FIG. 4a shows the connection device of FIG. 3a in the installed state. FIG. 4c shows the installed connection device in a side view looking toward the side wall 10b of the drawer 10, and FIG. 4b shows the connection device in a bottom view looking toward the bottom 10a of the drawer 10.

The connection device shown in FIGS. 3a through 4c is a reversal of the connection device shown in FIGS. 1a through 2c. Accordingly, in this embodiment of FIGS. 3a-4c, the bottom 10a of the drawer 10 forms the first furniture component and the slide rail 11 having the attached guide plate 14 forms the second furniture component.

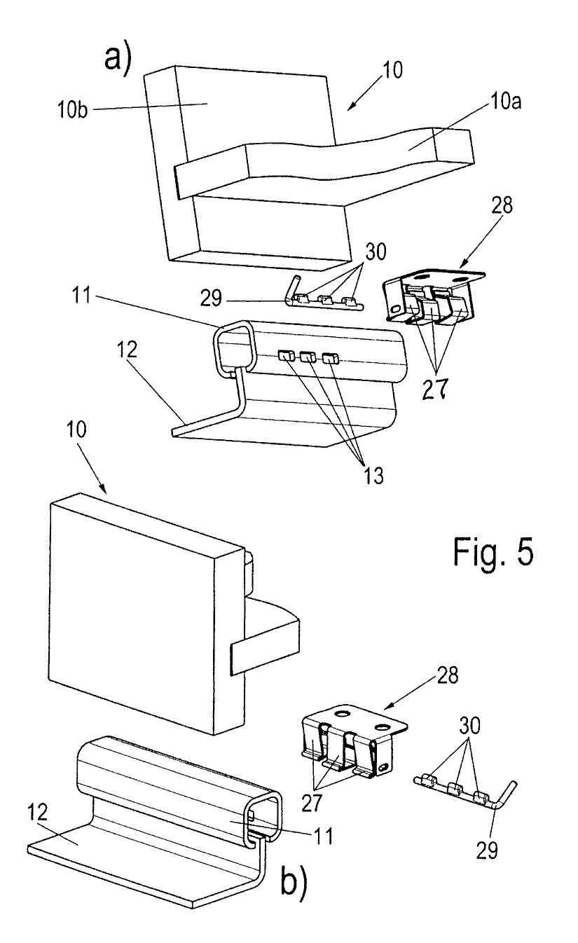

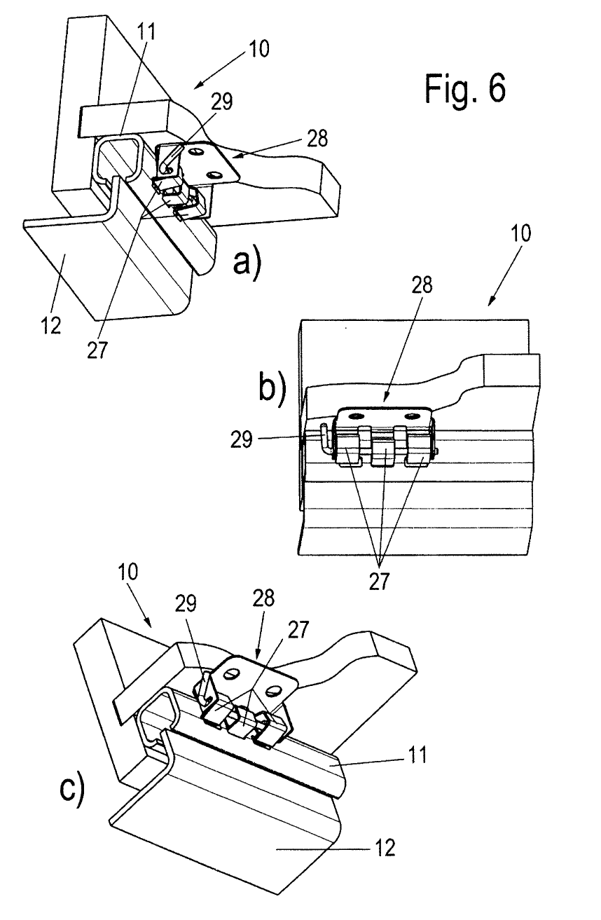

FIGS. 5a, 5b, 6a, 6b, and 6c show a third embodiment of the connection device according to the present disclosure. FIG. 5a shows the connection device in a perspective exploded view looking toward the inner surface of the side wall 10b of the drawer 10 and FIG. 5b shows this embodiment looking toward the outer surface of the side wall 10b of the drawer 10. FIG. 6a shows this connection device in the installed state in a perspective view looking toward the slide rail 11 and the lower side of the bottom 10a of the drawer 10. FIG. 6b shows this connection device in a side view and FIG. 6c shows this connection device in a perspective view looking toward the lower surface of the bottom 10a of the drawer 10.

As shown in FIG. 5a, the adjustment holes 13 are situated in the slide rail 11 in this embodiment, but in contrast to an above-described embodiment, for example, in FIGS. 1a-2c, the holes 13 are rectangular, and the distances between the holes 13 again being equal. Instead of connection bolts 17, spring tongues 27 engage in the adjustment holes 13. Spring tongue 27 are shaped on a holder 28, which has a fastening plate in order to fix it on the lower side of the bottom 10a of the drawer 10. The distances between the spring tongues 27 deviate from the distances between the adjustment holes 13. As FIGS. 6a and 6c show, the middle spring tongue 27 is pivoted into the associated adjustment hole 13. Depending on the position of the drawer 10 to the slide rail 11, one of the outer spring tongues 27 can also pivot into the associated adjustment hole 13.

To unlock the spring tongue 27, the holder 28 is equipped with an unlocking bar 29, which carries three spaced-apart unlocking cams 30. By rotating the unlocking bar 29, the spring tongue 27 that was pivoted into an adjustment hole 13 can be pressed out of the adjustment hole 13, so that the mutual adjustment of the drawer 10 to the slide rail 11 can be performed.

In this embodiment of FIGS. 5a-6c, the slide rail 11 forms the first furniture component and the drawer 10 having the holder 28 attached to the bottom 10a forms the second furniture component. It is within the scope of the present disclosure for first and second furniture components to be reversed.

The present disclosure is not restricted to the illustrated exemplary embodiments. It is essential that the furniture components 10, 11 are adjustable with respect to one another and connected to one another via a connection device. That connection device is without adjustment screws or similar components having to be turned using a tool. The adjustment holes 13 engage in one furniture component and connection elements in the form of connection bolts 17 or spring tongues 27 engage in the other furniture component. Furthermore, it is essential that the distances between the adjustment holes 13 and the distances between the connection elements 17, 27 deviate from one another.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A connection device for connecting first and second furniture components to one another, which furniture components are adjustable with respect to one another, the connection device comprising:
at least two connection elements spaced-apart from one another and located on the second furniture component;
at least two adjustment holes spaced-apart from one another and located on the first furniture component; and
wherein distances between the at least two connection elements are different from distances between the at least two adjustment holes, and the at least two connection elements and the at least two adjustment holes lie in a common displacement plane.

2. The connection device according to claim 1, wherein the at least two adjustment holes are three spaced-apart adjustment holes and the at least two connection elements are three spaced-apart connection elements.

3. The connection device according to claim 1, wherein the distances between the at least two connection elements are greater than the distances between the at least two adjustment holes.

4. The connection device according to claim 1, wherein the at least two connection elements are connection bolts which are movable in a longitudinal direction of the at least two adjustment holes.

5. The connection device according to claim 4, wherein each connection bolt is loaded by a force accumulator.

6. The connection device according to claim 4, wherein each connection bolt is inserted in a guide of a guide plate which is fixed on either the first or the second furniture component.

7. The connection device according to claim 6, wherein the connection bolts are provided on end areas facing toward the force accumulators, each locking bolt including an unlocking pin running transversely to a central longitudinal axis of the connection bolt.

8. The connection device according to claim 7, wherein the guide includes openings at least on a side facing toward the unlocking pins.

9. The connection device according to claim 8, wherein the guide plate is fixedly connected to either the first or second furniture component, and an unlocking slide, which is operationally linked to the unlocking pins, and which is displaceable in a longitudinal direction of the unlocking bolts, is situated on the side associated with the unlocking pins.

10. The connection device according to claim 9, wherein the unlocking slide includes an unlocking web which includes recesses in which the unlocking pins engage.

11. The connection device according claim 9, wherein an unlocking lever, on which the unlocking slide is linked, is mounted to be pivotable on the guide plate.

12. The connection device according to claim 1, wherein the at least two connection elements are spring tongues which are attached to a holder, which holder is attached to the first furniture component.

13. The connection device according to claim 12, wherein an unlocking bar including unlocking cams is mounted to be rotatable in the holder.

14. The connection device according to claim 1, wherein the distances between the at least two connection elements is less than the distances between the at least two adjustment holes.

15. The connection device according to claim 5, wherein the force accumulator is a compression spring.

16. The connection device according to claim 1, wherein the at least two connection elements are spring tongues which are molded on a holder, which holder is molded on the first furniture component.

17. The connection device according to claim 16, wherein an unlocking bar including unlocking cams is mounted to be rotatable in the holder.
